(19) United States
(12) Patent Application Publication
(10) Pub. No.: US 2017/0343199 A1
(43) Pub. Date: Nov. 30, 2017

(54) LUMINAIRE

(71) Applicant: Panasonic Intellectual Property Management Co., Ltd., Osaka (JP)

(72) Inventors: Takaaki UKEDA, Osaka (JP); Yoshiaki HONDA, Kyoto (JP); Shigeo GOTOH, Osaka (JP); Tadashi MURAKAMI, Osaka (JP)

(21) Appl. No.: 15/604,200

(22) Filed: May 24, 2017

(30) Foreign Application Priority Data
May 27, 2016 (JP) 2016-106570

(51) Int. Cl. F21V 23/04; G01S 13/56; G01S 13/88; G01S 7/02

(52) U.S. Cl. CPC F21V 23/0471; G01S 13/88; G01S 13/56; G01S 2007/027

(57) ABSTRACT

A luminaire includes a radio wave sensor, a luminaire body and a cover. The radio wave sensor is configured to detect, using radio waves, movement of an object within a detection area by a Doppler Effect due to the movement of the object. The luminaire body holds the radio wave sensor. The cover is attached to the luminaire body and covers the radio wave sensor, the cover allowing the radio waves to pass through. The radio wave sensor includes an antenna for transmitting/receiving the radio waves. An antenna face (receiving surface) of the antenna for receiving the radio waves is inclined relative to the cover.

### CROSS-REFERENCE TO RELATED APPLICATION

This application is based upon and claims the benefit of priority of Japanese Patent Application No. 2016-106570, filed on May 27, 2016, the entire content of which is incorporated herein by reference.

### TECHNICAL FIELD

This disclosure relates generally to luminaires and, more particularly, to a luminaire that includes a radio wave sensor for detecting an object.

### BACKGROUND ART

Conventionally, there has been proposed a luminaire that detects a human body with a Doppler sensor transmitting/receiving radio waves and switches turning-on and turning-off of a light source in accordance with a result about whether or not the human body is detected, which is disclosed in e.g., a Document 1 (JP 2012-113904 A). The luminaire disclosed in the Document 1 includes a fluorescent lamp, the Doppler sensor, a luminaire body for holding the fluorescent lamp, a cover, and a supporting body.

The cover is made of material having a light transmitting property. The cover is fixed to the luminaire body so as to form, between itself and the luminaire body, a space where the fluorescent lamp and the Doppler sensor are housed. The supporting body is disposed between the luminaire body and the cover in order to secure a sufficient distance between the luminaire body and the cover.

However, in the luminaire as the above conventional example, if a part of the radio waves is reflected by the cover while the cover is vibrated, a Doppler Effect occurs in reflection waves, and erroneous detection may therefore occur in the Doppler sensor (radio wave sensor).

### SUMMARY

The present disclosure is directed to a luminaire, which can reduce occurrence of erroneous detection due to reflection waves reflected by a cover.

A luminaire according to an aspect of the present disclosure includes a radio wave sensor, a luminaire body and a cover. The radio wave sensor is configured to detect, using radio waves, movement of an object within a detection area by a Doppler Effect due to the movement of the object. The luminaire body holds the radio wave sensor. The cover is attached to the luminaire body and covers the radio wave sensor, the cover allowing the radio waves to pass through. The radio wave sensor includes an antenna for transmitting/receiving the radio waves. A receiving surface of the antenna for receiving the radio waves is inclined relative to the cover.

### BRIEF DESCRIPTION OF THE DRAWINGS

The figures depict one or more implementations in accordance with the present disclosure, by way of example only, not by way of limitations. In the figures, like reference numerals refer to the same or similar elements.

FIG. 1A is a perspective view of a luminaire according to an Embodiment 1. FIG. 1B is a cross-sectional view illustrating an arrangement of a radio wave sensor and a cover in the luminaire according to the Embodiment 1.

FIG. 2 is a drawing for explaining one application example of the luminaire.

FIG. 3 is a block diagram of the radio wave sensor in the luminaire.

FIGS. 4A and 4B are drawings each for explaining influence of a cover vibration signal on the radio wave sensor.

FIG. 5A is a graph illustrating a frequency analysis result when the radio wave sensor is not covered with the cover. FIG. 5B is a graph illustrating a frequency analysis result when the radio wave sensor is covered with the cover.

FIG. 6 is a correlation diagram between: the shortest distance between the radio wave sensor and the cover; and a signal level of a differential signal.

FIG. 7A is a perspective view of a luminaire according to an Embodiment 2. FIG. 7B is a cross-sectional view illustrating an arrangement of a radio wave sensor and a cover in the luminaire according to the Embodiment 2.

FIG. 8A is a graph illustrating an experiment result when an antenna is not inclined.

FIG. 8B is a graph illustrating an experiment result when the antenna is inclined at an inclination angle of 22.5°.

FIG. 9 is a drawing for explaining a propagation path of radio waves in the luminaire according to the Embodiment 2.

### DETAILED DESCRIPTION

Hereinafter, luminaires according to Embodiments 1 and 2 will be described. However, configurations mentioned below are merely examples of the present disclosure. The present disclosure is not limited to the configurations mentioned below. Even in other than the configurations mentioned below, numerous modifications and variations can be made according to designs and the like without departing from the technical ideas according to the present disclosure.

### Embodiment 1

### (1) Outline

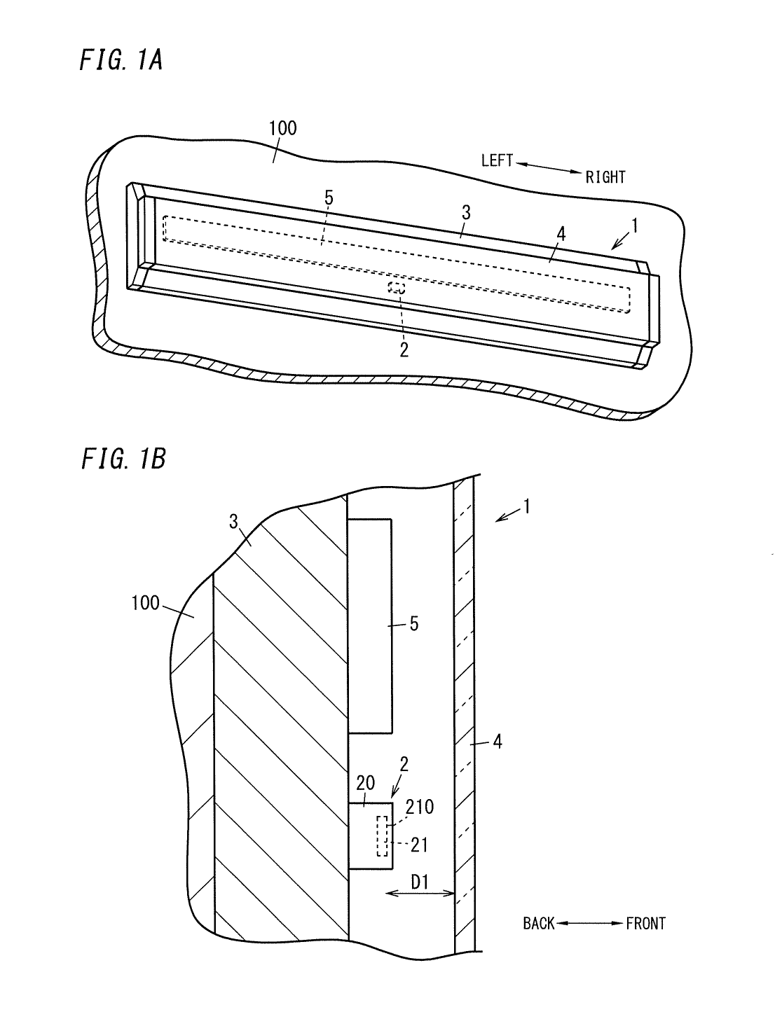

As shown in FIGS. 1A and 1B, a luminaire 1 according to an Embodiment 1 includes a radio wave sensor 2, a luminaire body 3 and a cover 4. The radio wave sensor 2 is configured to detect, using radio waves as a medium, movement of an object within a detection area by a Doppler Effect due to the movement of the object. The luminaire body 3 holds the radio wave sensor 2. The cover 4 is attached to the luminaire body 3 and covers the radio wave sensor 2, and the cover 4 allows the radio waves to pass through.

The radio wave sensor 2 includes an antenna 21 for transmitting/receiving the radio waves. The antenna 21 is disposed at a position where a shortest distance D1 between an antenna face (a receiving surface) 210 thereof for receiving the radio waves and the cover 4 is equal to or more than twice as long as a wavelength of a radio wave to be transmitted by the radio wave sensor 2.

### (2) Details

Hereinafter, the luminaire 1 according to the present embodiment will be described with reference to FIGS. 1A to 6. In the following explanations, directions (right, left, front and back directions) are defined by arrows shown in FIGS. 1A and 1B. Those arrows are illustrated merely for convenience of explanation, and the arrows each do not have an entity. The purpose of the directions defined above is not to restrict a use form of the luminaire 1 of the present embodiment.

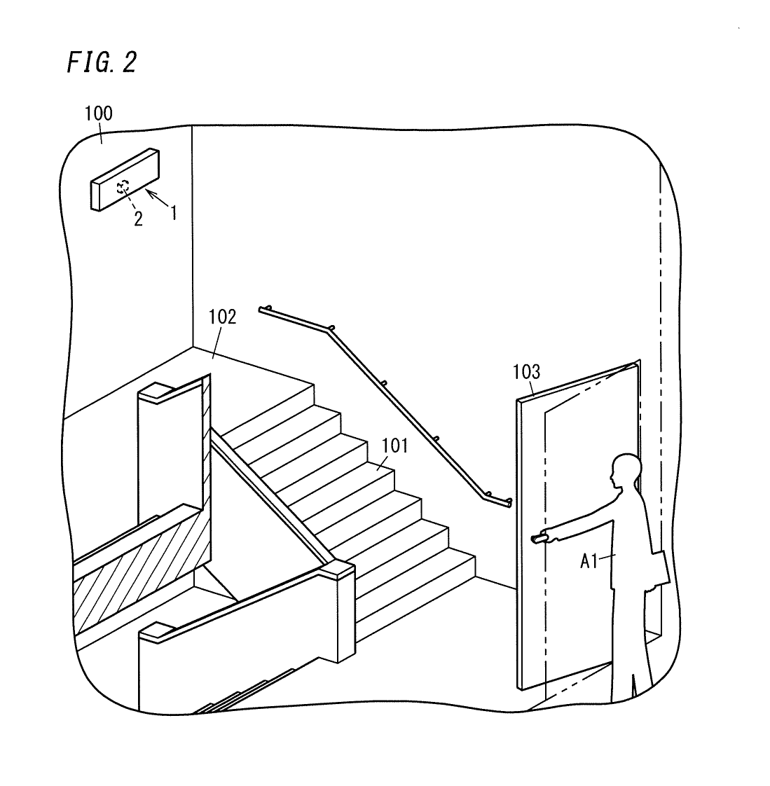

As shown in FIGS. 1A and 1B, the luminaire 1 of the present embodiment includes a radio wave sensor 2, a luminaire body 3 and a cover 4. As shown in FIG. 2, the luminaire 1 of the present embodiment may be installed to a wall 100 on a landing 102 of a stairway 101 that corresponds to an evacuation route in a building. In the illustrated example of FIG. 2, the luminaire 1 is disposed, for example, at a position where the stairway 101, the landing 102 and a door 103 of a gateway for leading to the stairway 101 are included in a detection area of the radio wave sensor 2.

The radio wave sensor 2 is configured to detect, with e.g., millimeter wave band radio waves as a medium, movement of an object. In the present embodiment, the radio wave sensor 2 detects, using radio waves having a frequency of 24 GHz as a medium, the movement of the object. Specifications such as a frequency band and antenna power to be used for the radio wave sensor 2 are defined in various countries. In Japan, the frequency to be used for the radio wave sensor 2 is, for example, 24 GHz as described above. In the present embodiment, the object that is a target to be detected by the radio wave sensor 2 is, for example, a human A1 or the door 103 (refer to FIG. 2).

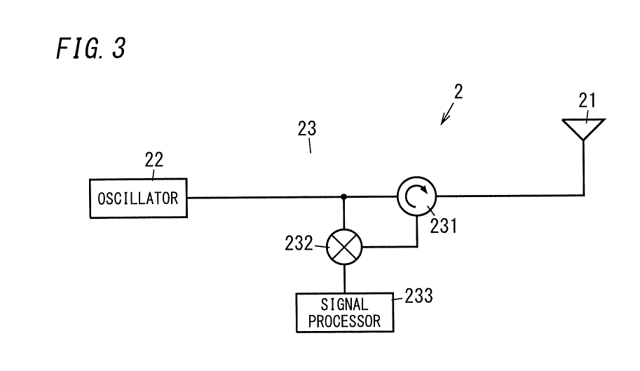

As shown in FIG. 3, the radio wave sensor 2 includes an antenna 21, an oscillator 22 and a detector 23. As shown in FIG. 1, the antenna 21, the oscillator 22 and the detector 23 are housed in a casing 20 having a rectangular parallelepiped shape.

The antenna 21 is formed as a planar antenna such as a microstrip antenna. The antenna 21 is configured to transmit, as radio waves, an oscillation signal made by the oscillator 22, and output, as a receiving signal, radio waves received. That is, the antenna 21 is configured to transmit/receive radio waves. In the present embodiment, since the radio waves having the frequency of 24 GHz are used as a medium as described above, the antenna 21 is configured to receive radio waves in a frequency band that includes the frequency of 24 GHz.

In the present embodiment, an antenna face 210 (refer to FIG. 1B), which is a front surface of the antenna 21, functions as a transmitting surface for transmitting radio waves forward, and a receiving surface for receiving radio waves. The antenna face 210 is provided so as to face the outside from an opening formed in a front surface of the casing 20. The antenna face 210 is not exposed from the casing 20, but covered with an antenna cover that is made of resin allowing radio waves to pass through. The antenna cover functions as a protector that protects the antenna 21 from foreign matters (for example, dusts). It further functions as a lens that defines a directivity of radio waves to be transmitted from the antenna 21 when the thickness or the like of the antenna is designed adequately. Because the antenna 21 and the antenna cover are vibrated integrally with each other, the antenna cover is not relatively vibrated with respect to the antenna 21, and accordingly, a change in a frequency hardly occurs. As a result, installation of the antenna cover hardly affects the movement detection for an object, performed by the radio wave sensor 2.

As shown in FIG. 3, the detector 23 includes a circulator 231, a mixer 232 and a signal processor 233. The circulator 231 is configured to output, to the antenna 21, the oscillation signal received from the oscillator 22, and output, to the signal processor 233, the receiving signal received from the antenna 21. The mixer 232 is configured to mix (multiple) the oscillation signal and the receiving signal, and then output a signal obtained by mixing to the signal processor 233.

When an object is present within the detection area of the radio wave sensor 2, a part of the radio waves transmitted from the antenna 21 is reflected by the object. The antenna 21 then receives the part reflected by the object, of the radio waves, and outputs it as the receiving signal to the circulator 231. A frequency of the receiving signal is different, by a frequency depending on a moving speed of the object, from a frequency of the radio waves transmitted, due to a Doppler Effect. Accordingly, a signal output from the mixer 232 to the signal processor 233 has a frequency that is a difference between the frequency of the radio waves and the frequency of the receiving signal (hereinafter, this signal is referred to as a “differential signal”).

The signal processor 233 includes, for example, a microcomputer as a main component. The microcomputer executes, with a CPU (Central Processing Unit), a program stored in its memory, thereby realizing a function as the signal processor 233. The signal processor 233 performs a processing to compare a signal level of the differential signal received from the mixer 232 with a threshold value. The signal processor 233 is configured to output, when the signal level of the differential signal exceeds the threshold value, a signal (detection signal) indicating that moving of an object has been detected to a control unit (described later). “Output the detection signal” mentioned herein means that, for example, output the detection signal with an H-level to the control unit, the detection signal being a binary signal capable of taking two signal levels of an L-level (Low level) and the H-level (High level). In other words, while moving of an object is not detected, the signal processor 233 is outputting the detection signal with the L-level to the control unit.

That is, the radio wave sensor 2 is configured to process the differential signal caused by the moving of the object, using the radio waves as a medium, to detect the moving of the object within the detection area. In other words, the radio wave sensor 2 is configured to utilize the Doppler Effect caused by the moving of the object, using the radio waves as a medium, to detect the moving of the object within the detection area. Here, the detection area of the radio wave sensor 2 is in an area where reflection waves reflected by the object, of the radio waves transmitted from the antenna 21, can have a signal intensity higher than a reception sensitivity of the radio wave sensor 2. In the present embodiment, the detection area includes at least the landing 102, the stairway 101 directly connected to the landing 102, and the door 103 (refer to FIG. 2).

The luminaire body 3 is formed as a box elongated along the right-left direction and having an opened front face by, for example, bending a metal plate. As shown in FIG. 1A, the luminaire body 3 houses therein the radio wave sensor 2 and a light source 5. In other words, the luminaire body 3 holds the radio wave sensor 2 and the light source 5. In addition, the luminaire body 3 houses therein a power supply unit and the control unit. Furthermore, an emergency light source and an emergency power supply unit are attached to the luminaire body 3. The emergency light source is lit up when a commercial power supply fails. The emergency power supply unit is provided to light up the emergency light source.

The light source 5 is an LED (Light Emitting Diode) module, elongated along the right-left direction and having a flat plate shape. The LED module includes, for example, a flat-plate shaped substrate elongated along the right-left direction, and LEDs mounted on a front surface of the substrate. The light source 5 is attached to the luminaire body 3 by, for example, hooking a hook fitting provided at the light source 5 on a stopper provided at the luminaire body 3.

The control unit is configured to operate with electric power supplied by the commercial power supply, and control turning-on/turning off of the light source 5 in accordance with the detection signal received from the radio wave sensor 2. For example, while the control unit receives the detection signal with the H-level from the radio wave sensor 2, the control unit gives the control signal indicating turning-on of the light source 5 to the power supply unit to turn on the light source 5. For example, after the lapse of a predetermined waiting time period (e.g., several ten seconds) from a time point when the detection signal from the radio wave sensor 2 is stopped, the control unit gives the control signal indicating turning-off or dimming of the light source 5 to the power supply unit to turn off or dim the light source 5. The “time point when the detection signal from the radio wave sensor 2 is stopped” mentioned herein means, for example, “a time point when the signal level of the detection signal is switched from the H-level to the L-level”.

In the present embodiment, the control unit allows the light source 5 to turn on, when the radio wave sensor 2 detects that the door 103 is moved from a position of a closed state to a position of an opened state (namely, movement of an object). That is, the light source 5 is lit up at a time point when the human A1 opens the door 103, namely, before the human A1 reaches the front of the stairway 101. In the present embodiment, the control unit allows the light source 5 to turn off or dim, after the lapse of the predetermined waiting time period from a time point when the detection result of the radio wave sensor 2 is changed from that the object is moved within the detection area to that not moved. That is, the human A1 moves out of the detection area, and then after a while, the light source 5 is lit off or lit up in a dimmed state.

The power supply is configured to convert AC power supplied from the commercial power supply to DC power, and supply the converted DC power to the light source 5. The power supply is further configured to increase/decrease the DC power to be supplied to the light source 5 in accordance with the control signal output from the control unit. For example, the power supply unit supplies, to the light source 5, the DC power required for turning on the light source 5, when receiving the control signal indicating turning-on of the light source 5 from the control unit. The power supply unit stops supplying of the DC power to the light source 5, when receiving the control signal indicating turning-off of the light source 5 from the control unit.

The cover 4 is made of material having a light transmitting property so as to have a flat plate shape elongated along the right-left direction. In the present embodiment, the cover 4 is made of glass. The cover 4 is attached to the luminaire body 3 so as to cover the front surface of the luminaire body 3. In other words, the cover 4 is attached to the luminaire body 3 so as to cover the radio wave sensor 2 and the light source 5. The cover 4 is attached to the luminaire body 3 so that a rear surface (or a front surface) of the cover 4 is in parallel with the antenna face (receiving surface) 210 of the radio wave sensor 2. The cover 4 is configured to allow the radio waves and light emitted from the light source 5 to at least partially pass through. The rear surface (or the front surface) of the cover 4 may be inclined relative to the antenna face (receiving surface) 210 of the radio wave sensor 2.

Here, in the luminaire 1 of the present embodiment, the radio wave sensor 2 is covered with the cover 4, as shown in FIG. 1A. Therefore, since the radio wave sensor 2 is hardly visually identified, the luminaire 1 of the present embodiment is excellent in designability, compared with a case where the radio wave sensor 2 is exposed. However, when the radio wave sensor 2 is covered with the cover 4, there is a possibility that the radio wave sensor 2 may erroneously detect movement of an object.

Hereinafter, this possibility will be described in more detail. The building to which the luminaire 1 is installed may be vibrated, for example, by walking actions of persons existing in the building or operation of equipment, such as air conditioners, installed in the building. In addition, the building may be vibrated, for example, by receiving of the wind or cars passing on roads around the building. When the building is vibrated, the radio wave sensor 2 and the cover 4 of the luminaire 1 are vibrated independently with each other.

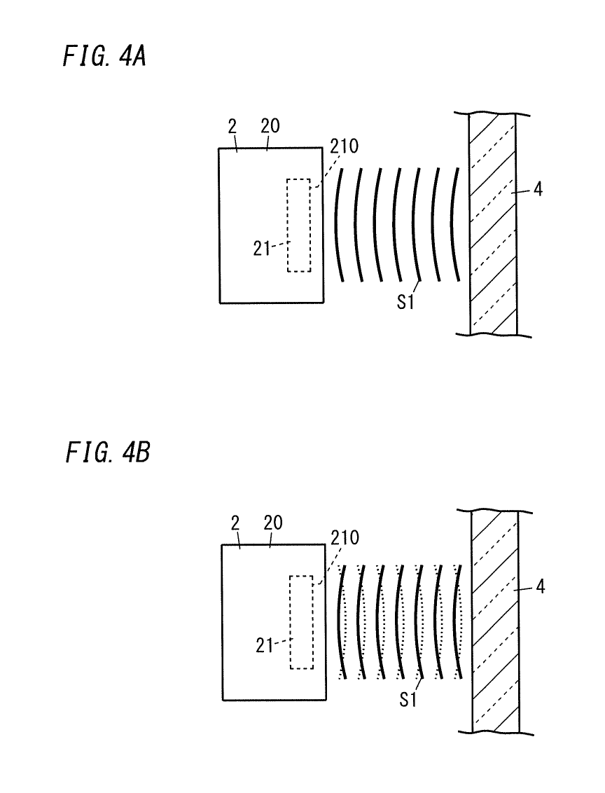

If a part of the radio waves transmitted from the radio wave sensor 2 is reflected by the cover 4, the reflection waves would be returned to the radio wave sensor 2 (refer to FIG. 4A). Hereinafter, the reflection waves are referred to as “cover reflection waves S1”. Since the cover 4 is relatively vibrated with respect to the radio wave sensor 2, the cover reflection waves S1 have a frequency different, due to the Doppler Effect, from a frequency of the radio waves transmitted from the radio wave sensor 2. When the detector 23 processes the cover reflection waves S1, the differential signal is obtained, and the radio wave sensor 2 may therefore erroneously detect movement of an object in spite of that no object is actually present within the detection area.

Furthermore, as shown in FIG. 4B, there is a possibility that the cover reflection waves S1 are repeatedly reflected between the antenna face 210 of the radio wave sensor 2 and the cover 4, namely, occurrence of so-called multiple reflections. Waveforms by solid lines in FIG. 4B represent reflection waves reflected by the cover 4, of the radio waves transmitted from the radio wave sensor 2. Waveforms by broken lines in FIG. 4B represent reflection waves further reflected by the radio wave sensor 2, of the reflection waves from the cover 4.

The radio wave sensor 2 receives both of the cover reflection waves S1 and the multiple reflected cover reflection waves S1. Since the cover reflection waves S1 are not radio waves reflected by an object moving within the detection area, they are a noise for the radio wave sensor 2. In particular, when a distance between the antenna face 210 of the radio wave sensor 2 and the cover 4 is equal to a half of a wavelength of the radio waves transmitted from the radio wave sensor 2, the noise is increased by the influence of standing waves.

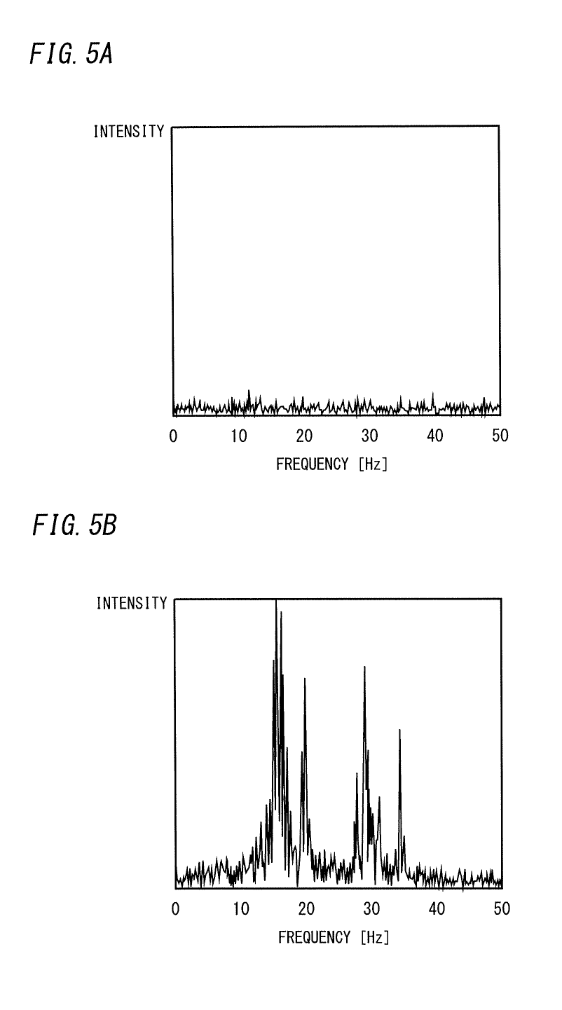

FIG. 5A shows a frequency analysis result of the differential signal, performed under a condition that the radio wave sensor 2 was not covered with the cover 4. On the other hand, FIG. 5B shows a frequency analysis result of the differential signal, performed under a condition that the radio wave sensor 2 was covered with the cover 4. Those frequency analyses were performed under the same condition that no object was present within the detection area of the radio wave sensor 2. In each of FIGS. 5A and 5B, its vertical axis and its horizontal axis respectively represent an intensity of a frequency spectrum of the differential signal and a frequency of the differential signal.

As shown in FIG. 5B, the intensity of the frequency spectrum of the differential signal is relatively large in a range of the frequency from about 10 to 30 Hz. That is, it can be understood that the radio wave sensor 2 involuntarily obtains the differential signal having the frequency of about 10 to 30 Hz with the intensity equal to or more than a prescribed intensity (the threshold value of the signal processor 233) due to the cover reflection waves S1. Here, the differential signal caused by the walking action of the human A1 is generally known to be a signal having a frequency of about 50 to 200 Hz, and accordingly, it can be understood that the cover reflection waves S1 would not affect the radio wave sensor 2. However, for example, when the human A1 is an aged man or a person the leg of which is injured, the walking speed is relatively low, and accordingly, the differential signal caused by the walking action of such the human A1 may have a lower frequency. Furthermore, when the door 103 is opened or closed at a relatively low speed, the differential signal caused by opening or closing of the door 103 may also have a lower frequency. Therefore, when the radio wave sensor 2 obtains the differential signal with the intensity equal to or more than the prescribed intensity due to the cover reflection waves S1, the radio wave sensor 2 may erroneously detect that the walking action of the human A1 or the opening or closing of the door 103 has occurred.

In order to solve the above problems, the inventors of the present application carried out an experiment to verify the influence of the cover reflection waves S1 on the radio wave sensor 2. As a result, the inventors of the present application obtained that the signal level of the differential signal based on the cover reflection waves S1 is changed, depending on the shortest distance D1 (refer to FIG. 1B) between the antenna face (receiving surface) 210 of the antenna 21 and the cover 4. Furthermore, the inventors of the present application obtained, by the experiment result, that the influence of the cover reflection waves S1 on the radio wave sensor 2 can be reduced by setting the shortest distance D1 to be equal to or more than twice as long as a wavelength of the radio waves, and it is accordingly possible to reduce occurrence of erroneous detection regarding movement of an object by the radio wave sensor 2.

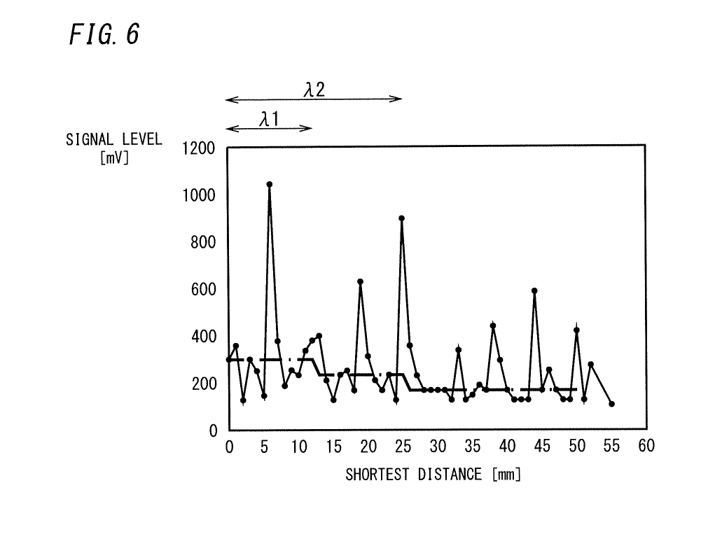

FIG. 6 shows the experiment result. More specifically, FIG. 6 represents the experiment result in that the signal level of the differential signal was measured by an oscilloscope, while changing the shortest distance D1 between the antenna face (receiving surface) 210 of the radio wave sensor 2 and the cover 4. In the experiment, the thickness dimension of the cover 4 (the size in the front-back direction) was 4 mm. The experiment was carried out under a condition that no object was present within the detection area of the radio wave sensor 2. Thus, the radio waves which the radio wave sensor 2 received were substantially the cover reflection waves S1.

In FIG. 6, its vertical axis and its horizontal axis respectively represent the signal level (the unit is [mV]) of the differential signal and the shortest distance D1 (the unit is [mm]). A dashed line in FIG. 6 represents an average value of the signal level of the differential signal. The signal level is a Peak-to-peak value of the differential signal.

As shown in FIG. 6, when the shortest distance D1 is in a range of “0” to “λ1”, the average value of the signal level (i.e., a noise level) of the differential signal is at about 300 mV. When the shortest distance D1 is in a range of “λ1” to “λ2”, the average value of the noise level is at about 220 mV. When the shortest distance D1 is in a range more than “λ2”, the average value of the noise level is at about 180 mV. The “λ1” corresponds to the wavelength of the radio waves to be transmitted by the radio wave sensor 2. Since the frequency of the radio waves to be transmitted by the radio wave sensor 2 is 24 GHz, “λ1=12.5 mm” is met. The “λ2” corresponds to a length twice as long as the wavelength of the radio waves to be transmitted by the radio wave sensor 2. In this case, “λ2=25 mm” is met.

As shown in FIG. 6, the noise level is decreased as the shortest distance D1 is increased. When the shortest distance D1 is increased to a value equal to or more than twice as long as the wavelength of the radio waves to be transmitted by the radio wave sensor 2, the average value of the noise level falls below 200 mV. On the other hand, under the condition that the radio wave sensor 2 was not covered with the cover 4, the same experiment as the above was carried out, and in this case, the noise level was at about 100 mV. Thus, it can be considered that, if the average value of the noise level falls below 200 mV under the condition that the radio wave sensor 2 is covered with the cover 4, it is possible to sufficiently reduce the possibility that the erroneous detection by the radio wave sensor 2 occurs.

As described above, in the luminaire 1 of the present embodiment, the antenna 21 is disposed at a position where the shortest distance D1 between the antenna face (receiving surface) 210 for receiving radio waves and the cover 4 is equal to or more than twice as long as a wavelength of radio waves to be transmitted by the radio wave sensor 2. For this reason, in the luminaire 1 of the present embodiment, since the antenna 21 of the radio wave sensor 2 hardly receives the cover reflection waves S1, the influence of the cover reflection waves S1 on the radio wave sensor 2 can be reduced. Therefore, in the luminaire 1 of the present embodiment, it is possible to reduce the possibility that the radio wave sensor 2 obtains the differential signal with the intensity equal to or more than the prescribed intensity due to the cover reflection waves S1, and further the possibility that the radio wave sensor 2 erroneously detects that the walking action of the human A1 or the opening or closing of the door 103 has occurred. That is, in the luminaire 1 of the present embodiment, the erroneous detection due to the reflection waves (cover reflection waves S1) reflected by the cover 4 hardly occurs.

However, increase in the shortest distance D1 may cause a problem such as attenuation of the radio waves or increase in the size of the luminaire 1 in the front-back direction. From this view, preferably, the shortest distance D1 between the antenna face (receiving surface) 210 of the radio wave sensor 2 and the cover 4 is, for example, equal to about twice as long as the wavelength of the radio waves to be transmitted by the radio wave sensor 2. That is, preferably, the shortest distance D1 is equal to or more than twice as long as the wavelength of the radio waves to be transmitted by the radio wave sensor 2, and further, in an extent of not influencing the detection area of the radio wave sensor 2 and the size of the luminaire 1.

The Document 1 discloses a configuration that a distance between a radio wave sensor and a cover is set to an integral multiple of a half-wavelength of radio waves to be transmitted by the radio wave sensor in order to suppress attenuation of the radio waves, depending on the radio waves passing through the cover. This configuration contains also a case where the distance between the radio wave sensor and the cover is less than twice as long as the wavelength of the radio waves to be transmitted by the radio wave sensor. In such the case, since the radio wave sensor is influenced by the reflection waves reflected by the cover, it is difficult to reduce the possibility that the erroneous detection occurs. Furthermore, in this configuration, the distance between any region of the antenna face of the radio wave sensor and the cover does not meet the above mentioned condition. That is, this configuration has a possibility that, depending on a region of the antenna face, the antenna is easily influenced by the reflection waves reflected by the cover. In addition, because there is unevenness in processing upon manufacturing of the luminaire, it is not easy to strictly set the distance between the radio wave sensor and the cover to the integral multiple of the half-wavelength of the radio waves to be transmitted by the radio wave sensor.

On the other hand, in the luminaire 1 of the present embodiment, the shortest distance D1 between the antenna face (receiving surface) 210 of the radio wave sensor 2 and the cover 4 is set so as to be equal to or more than twice as long as the wavelength of the radio waves to be transmitted by the radio wave sensor 2. That is, a distance between any region of the antenna face (receiving surface) 210 and the cover 4 is made equal to or more than twice as long as the wavelength of the radio waves to be transmitted by the radio wave sensor 2. Thus, the luminaire 1 of the present embodiment can reduce the influence of the cover reflection waves S1 on the radio wave sensor 2 over the whole of the detection area, unlike the configuration disclosed in the Document 1. The luminaire 1 of the present embodiment does not need strict processing accuracy upon the manufacturing, compared with the configuration disclosed in the Document 1, and therefore also has an advantage that it is easy to manufacture the luminaire 1.

### Embodiment 2

### (1) Outline

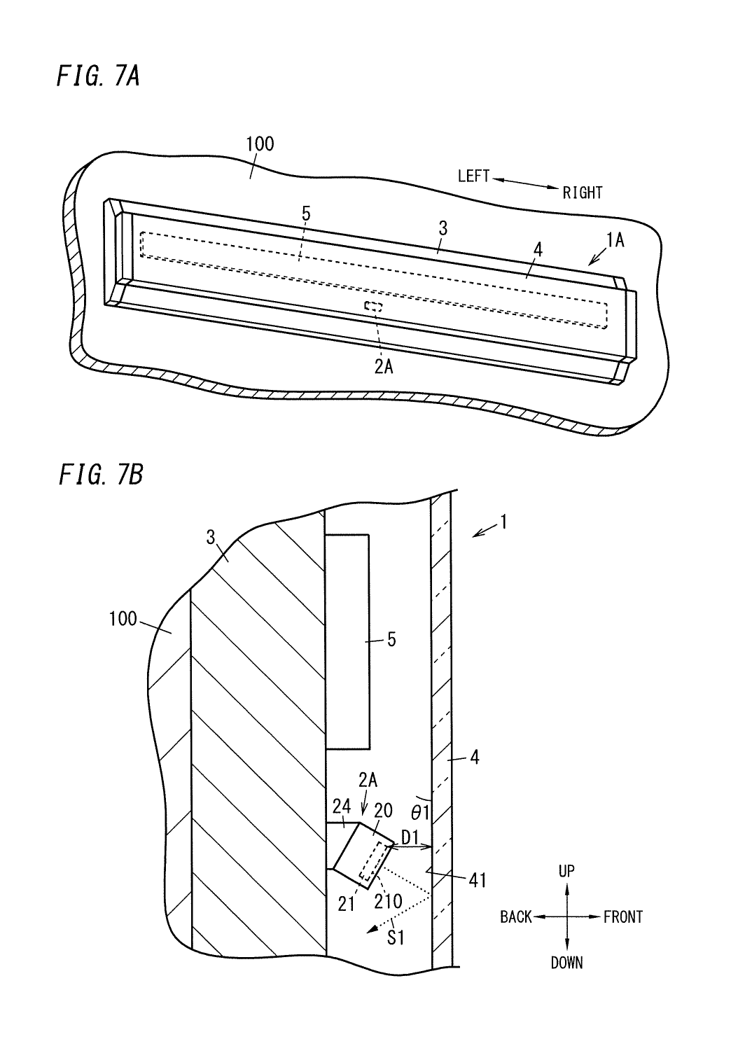

As shown in FIGS. 7A and 7B, a luminaire 1A according to an Embodiment 2 includes a radio wave sensor 2A, a luminaire body 3 and a cover 4. The radio wave sensor 2A is configured to detect, using radio waves as a medium, movement of an object within a detection area by a Doppler Effect due to the movement of the object. The luminaire body 3 holds the radio wave sensor 2A. The cover 4 is attached to the luminaire body 3 and covers the radio wave sensor 2A, and the cover 4 allows the radio waves to pass through.

The radio wave sensor 2A includes an antenna 21 for transmitting/receiving the radio waves. The antenna 21 is provided so that an antenna face (receiving surface) 210 for receiving the radio waves is inclined relative to the cover 4 (e.g., an inner surface 41 of the cover 4).

### (2) Details

Hereinafter, the luminaire 1A according to the Embodiment 2 will be described with reference to FIGS. 7A to 9. In the following explanations, directions (up, down, right, left, front and back directions) are defined by arrows shown in FIGS. 7A and 7B. Those arrows are illustrated merely for convenience of explanation, and the arrows each do not have an entity. The purpose of the directions defined above is not to restrict a use form of the luminaire 1A of the present embodiment. The luminaire 1A of the present embodiment is similar to the luminaire 1 of the Embodiment 1 other than that the radio wave sensor 2A is different from the radio wave sensor 2 of the Embodiment 1 and therefore, explanations for components similar to those of the luminaire 1 of the Embodiment 1 will be omitted.

As shown in FIGS. 7A and 7B, the luminaire 1A of the present embodiment includes the radio wave sensor 2A instead of the radio wave sensor 2 of the Embodiment 1. The radio wave sensor 2A is different from the radio wave sensor 2 of the Embodiment 1 in that the radio wave sensor 2A further includes a supporting block 24. The supporting block 24 is attached to the luminaire body 3. A casing 20 is attached to a front surface of the supporting block 24. The front surface of the supporting block 24 is inclined relative to the cover 4. That is, the supporting block 24 supports the casing 20 in a state where the casing 20 is inclined relative to the cover 4.

As a result, an antenna face (receiving surface) 210 of an antenna 21 housed in the casing 20 is also inclined relative to the cover 4. In other words, the antenna 21 is provided so that the antenna face (receiving surface) 210 is inclined relative to the cover 4. Hereinafter, an angle made by the antenna face (receiving surface) 210 and the rear surface of the cover 4 is referred to as an “inclination angle θ1 (0°<θ1<90°)” (refer to FIG. 7B). As one example, the inclination angle θ1 meets 10°<θ1<50°. The luminaire 1A of the present embodiment may be installed to, for example, a wall 100 on a landing 102 of a stairway 101, similarly to the luminaire 1 of the Embodiment 1. For this reason, the inclination angle θ1 is set to almost 22.5° so that the landing 102 is included in the detection area of the radio wave sensor 2A. The inclination angle θ1 may be appropriately modified, depending on an installation location of the luminaire 1A or the detection area of the radio wave sensor 2A.

The inventors of the present application carried out an experiment, different from the experiment mentioned in the Embodiment 1, to verify the influence of the cover reflection waves S1 on the radio wave sensor 2A. As a result, the inventors of the present application obtained that the influence of the cover reflection waves S1 on the radio wave sensor 2A can be reduced by making the antenna face (receiving surface) 210 of the antenna 21 so as to be inclined relative to the cover 4, and it is accordingly possible to reduce occurrence of erroneous detection regarding movement of an object by the radio wave sensor 2A.

For example, as shown in FIG. 7B, the radio waves are assumed to be transmitted from a center of the antenna face (transmitting surface) 210 of the radio wave sensor 2A toward the cover 4. In this case, a part of the radio waves incident on the cover 4 is reflected, as the cover reflection waves S1, by the cover 4. However, since the antenna face (transmitting surface) 210 is inclined at the inclination angle θ1 relative to the cover 4, a possibility that the cover reflection waves S1 is incident on the antenna face (receiving surface) 210 is reduced. Here, “the cover reflection waves S1 is incident on the antenna face (receiving surface) 210” means that “the cover reflection waves S1 is incident on the antenna face (receiving surface) 210, as radio waves having a signal intensity higher than a reception sensitivity of the radio wave sensor 2A”.

Thus, the luminaire 1A of the present embodiment can reduce the possibility that the cover reflection waves S1 multiple-reflect between the antenna face (receiving surface) 210 of the radio wave sensor 2A and the cover 4. That is, the luminaire 1A of the present embodiment can reduce the influence of the cover reflection waves S1 multiple-reflected on the radio wave sensor 2A.

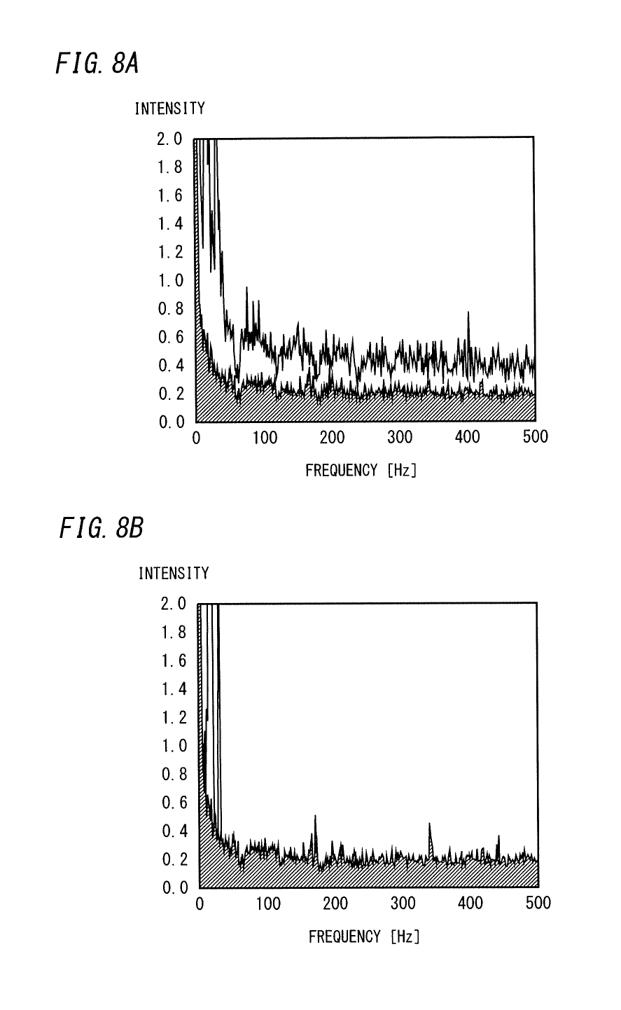

FIG. 8A shows a frequency analysis result of the differential signal, performed under a condition that the antenna face (receiving surface) 210 of the radio wave sensor 2A was not inclined relative to the cover 4. FIG. 8B shows a frequency analysis result of the differential signal, performed under a condition that the antenna face (receiving surface) 210 of the radio wave sensor 2A was inclined relative to the cover 4 (in this case, a condition that the inclination angle θ1 is 22.5°). Those frequency analyses were performed under the same condition that no object was present within the detection area of the radio wave sensor 2A.

In each of FIGS. 8A and 8B, its vertical axis and its horizontal axis respectively represent an intensity of a frequency spectrum of the differential signal (hereinafter, simply referred to as “the intensity of the differential signal”) and a frequency of the differential signal. In each of FIGS. 8A and 8B, a hatched part by oblique lines represents the frequency spectrum of the differential signal in the case where the radio wave sensor 2A was not covered with the cover 4. In each of FIGS. 8A and 8B, a hatched part by dots represents the frequency spectrum of the differential signal in the case where the radio wave sensor 2A was covered with the cover 4.

As shown in FIG. 8A, it can be found that, when the antenna face (receiving surface) 210 was not inclined relative to the cover 4, the intensity of the differential signal in the case with the cover 4 was larger than the intensity of the differential signal in the case without the cover 4 over the whole of the frequency range in which the frequency analysis was carried out. On the other hand, as shown in FIG. 8B, it can be found that, when the inclination angle θ1 is 22.5°, the intensity of the differential signal in the case with the cover 4 was substantially equal to the intensity of the differential signal in the case without the cover 4 over the whole of the frequency range in which the frequency analysis was carried out. That is, the influence of the cover reflection waves S1 on the radio wave sensor 2A can be reduced by making the antenna face (receiving surface) 210 so as to be inclined relative to the cover 4.

As mentioned above, in the luminaire 1A of the present embodiment, the antenna 21 is provided so that the antenna face (receiving surface) 210 for receiving the radio waves is inclined relative to the cover 4. Therefore, the luminaire 1A of the present embodiment can reduce the possibility that the cover reflection waves S1 are multiple-reflected, and the influence of the cover reflection waves S1 on the radio wave sensor 2A can be accordingly reduced. As a result, in the luminaire 1A of the present embodiment, it is possible to reduce the possibility that the radio wave sensor 2A obtains the differential signal with the intensity equal to or more than the prescribed intensity due to the cover reflection waves S1, and further the possibility that the radio wave sensor 2A erroneously detects that the walking action of the human A1 or the opening or closing of the door 103 has occurred. That is, in the luminaire 1A of the present embodiment, the erroneous detection due to the radio waves (cover reflection waves S1) reflected by the cover 4 hardly occurs.

In the luminaire 1A of the present embodiment, the antenna 21 is preferably disposed at a position where a shortest distance D1 between the antenna face (receiving surface) 210 and the cover 4 is equal to or more than the wavelength of the radio waves to be transmitted by the radio wave sensor 2A. According to this configuration, since the antenna 21 of the radio wave sensor 2A is made to hardly receive the cover reflection waves S1, the influence of the cover reflection waves S1 on the radio wave sensor 2A can be further reduced.

In particular, in the luminaire 1A of the present embodiment, the antenna 21 is preferably disposed at a position where the shortest distance D1 between the antenna face (receiving surface) 210 and the cover 4 is equal to or more than twice as long as the wavelength of the radio waves to be transmitted by the radio wave sensor 2A. According to this configuration, since the antenna 21 of the radio wave sensor 2A is made to hardly receive the cover reflection waves S1, the influence of the cover reflection waves S1 on the radio wave sensor 2A can be further reduced, compared with the configuration that the shortest distance D1 is equal to or more than the wavelength of the radio waves to be transmitted by the radio wave sensor 2A.

Furthermore, the luminaire 1A of the present embodiment is configured as shown in FIG. 7B. That is, the antenna face (receiving surface) 210 of the antenna 21 is provided so as to be inclined relative to the cover 4 by an angle at which the cover reflection waves S1 is not incident on the antenna face (receiving surface) 210, the cover reflection waves S1 having a signal intensity higher than a reception sensitivity of the radio wave sensor 2A. The cover reflection waves S1 are radio waves reflected by the cover 4, of radio waves transmitted by the radio wave sensor 2A. According to this configuration, since the cover reflection waves S1 are hardly reflected by the antenna face (receiving surface) 210 of the antenna 21, it is possible to further reduce the possibility that the cover reflection waves S1 are multiple-reflected.

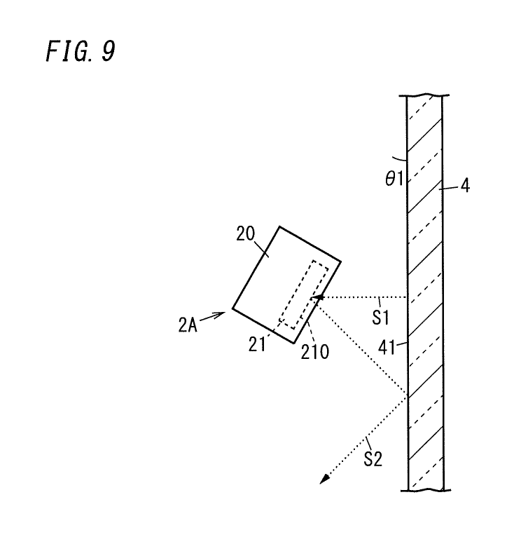

Alternatively, the luminaire 1A of the present embodiment may be configured as shown in FIG. 9. That is, the antenna face (receiving surface) 210 of the antenna 21 may be provided so as to be inclined relative to the cover 4 by an angle at which re-reflection waves S2 is not incident on the antenna face (receiving surface) 210. The re-reflection waves S2 are radio waves reflected by the cover 4 and the antenna face (receiving surface) 210 in this order and then again reflected by the cover 4, of radio waves transmitted by the radio wave sensor 2A. The “re-reflection waves S2 is not incident on the antenna face (receiving surface) 210” mentioned herein means “the re-reflection waves S2 is not incident on the antenna face (receiving surface) 210, as radio waves having a signal intensity higher than a reception sensitivity of the radio wave sensor 2A”. According to this configuration, even when the cover reflection waves S1 is incident on the antenna face (receiving surface) 210 of the antenna 21, the re-reflection waves S2, generated by the cover reflection waves S1 being further reflected, are hardly reflected by the antenna face 210. It is therefore possible to further reduce the possibility that the cover reflection waves S1 are multiple reflected.

In the luminaire 1A of the present embodiment, the inclination angle of the antenna face (receiving surface) 210 of the radio wave sensor 2A with respect to the cover 4 is not limited to the above-mentioned inclination angle. That is, in the luminaire 1A of the present embodiment, it is possible to reduce the possibility that the cover reflection waves S1 are multiple-reflected, only by making the antenna face (receiving surface) 210 of the radio wave sensor 2A so as to be inclined relative to the cover 4, regardless of a value of the inclination angle.

Incidentally, the cover 4 in each of the luminaires 1 and 1A of the Embodiments 1 and 2 is made of glass. According to this configuration, it is possible to realize the cover 4 that easily allows the radio waves transmitted by the radio wave sensors 2 and 2A to pass through. In particular, when each of the luminaires 1 and 1A of the Embodiments 1 and 2 is used as a luminaire for emergency, the cover 4 is preferably made of tempered glass in consideration of flame retardancy. Note that the matter that the cover 4 is made of glass is optional.

Alternatively, the cover 4 may be made of resin. In this case, it is possible to improve flexibility in the design of the cover 4, compared with a case where the cover 4 is made of only glass.

In particular, the cover 4 is preferably made of the resin that has a dielectric constant less than a dielectric constant of glass. The reflection of the radio waves by the cover 4 is further suppressed, as a dielectric constant is reduced. Accordingly, compared with the case where the luminaire includes the cover 4 made of glass, it is possible to further reduce the possibility that the cover reflection waves S1 are multiple-reflected and therefore further reduce occurrence of erroneous detection by the radio wave sensors 2 and 2A.

In each of the luminaires 1 and 1A of the Embodiments 1 and 2, the light source 5 may be a discharge lamp such as a fluorescent lamp or a high-luminance discharge lamp, instead of the LED module. When the discharge lamp is applied as the light source 5, the light source 5 is preferably further provided on a rear side thereof with a reflector to reflect light emitted backward by the light source 5 to the front. Also when the discharge lamp is applied as the light source 5, the power supply unit is preferably configured to supply AC power to the light source 5. The shape of the light source 5 is not limited to the above-mentioned shape. For example, the light source 5 may be an annular ring-shaped discharge lamp.

The luminaires 1 and 1A of the Embodiments 1 and 2 are installed to the wall 100 on the landing 102 of the stairway 101, but the installation location is not limited to the wall 100. For example, the luminaires 1 and 1A may be installed to a ceiling above the landing 102 of the stairway 101. In addition, the installation location of each of the luminaires 1 and 1A is not limited to the landing 102 of the stairway 101. For example, the luminaires 1 and 1A may be installed to a wall or a ceiling in a residential space of a building.

In the Embodiments 1 and 2, the cover 4 is configured to allow the light emitted by the light source 5 and the radio waves to pass through, but may have another configuration. For example, the cover 4 may be provided so as to cover only the radio wave sensor 2 and configured to allow only the radio waves to pass through. In this case, the light source 5 may be covered with a cover different from the cover 4.

In the Embodiments 1 and 2, the antenna 21 has the single antenna face 210 that serves as both a transmitting surface for transmitting radio waves and a receiving surface for receiving radio waves, but the transmitting and receiving surfaces may be provided independently with each other. Alternatively, the radio wave sensor 2 may include a transmitting antenna and a receiving antenna, instead of the antenna 21 serving as both transmitting and receiving.

As apparent from the above explanations, a luminaire (1A) of a first aspect includes a radio wave sensor (2A), a luminaire body (3) and a cover (4). The radio wave sensor (2A) is configured to detect, using radio waves, movement of an object within a detection area by a Doppler Effect due to the movement of the object. The luminaire body (3) holds the radio wave sensor (2A). The cover (4) is attached to the luminaire body (3) and covers the radio wave sensor (2A), the cover (4) allowing the radio waves to pass through. The radio wave sensor (2A) includes an antenna (21) for transmitting/receiving the radio waves. An antenna face (receiving surface) (210) of the antenna (21) for receiving the radio waves is inclined relative to the cover (4) (e.g., an inner surface (41) of the cover (4)).

Regarding a luminaire (1A) of a second aspect, in the first aspect, the antenna (21) is disposed at a position where a shortest distance (D1) between the receiving surface (210) and the cover (4) is equal to or more than a wavelength of the radio waves to be transmitted by the radio wave sensor (2A).

Regarding a luminaire (1A) of a third aspect, in the second aspect, the antenna (21) is disposed at a position where the shortest distance (D1) between the receiving surface (210) and the cover (4) is equal to or more than twice as long as the wavelength of the radio waves to be transmitted by the radio wave sensor (2A).

Regarding a luminaire (1A) of a fourth aspect, in any one of the first to the third aspects, the receiving surface (210) of the antenna (21) is provided so as to be inclined relative to the cover (4) (e.g., the inner surface (41) of the cover (4)) by the following angle: that is, the angle at which a specific radio wave reflected by the cover (4), of radio waves transmitted by the radio wave sensor (2A), is not incident on the receiving surface (210), the specific radio wave having a signal intensity higher than a reception sensitivity of the radio wave sensor (2A). In other words, an inclination angle (01) of the receiving surface (210) of the antenna (21) relative to the cover (4) (e.g., the inner surface (41) of the cover (4)) is set such that no reflected radio wave, which is transmitted by the radio wave sensor (2A) and reflected by the cover (4) and has a signal intensity higher than a reception sensitivity of the radio wave sensor (2A), is incident on the receiving surface (210) of the antenna (21).

Regarding a luminaire (1A) of a fifth aspect, in any one of the first to the third aspects, the receiving surface (210) of the antenna (21) is provided so as to be inclined relative to the cover (4) (e.g., the inner surface (41) of the cover (4)) by the following angle: that is, the angle at which a specific radio wave reflected by the cover (4) and the receiving surface (210) in this order and then again reflected by the cover (4), of radio waves transmitted by the radio wave sensor (2A), is not incident on the receiving surface (210), the specific radio wave having a signal intensity higher than a reception sensitivity of the radio wave sensor (2A). In other words, an inclination angle (01) of the receiving surface (210) of the antenna (21) relative to the cover (4) (e.g., the inner surface (41) of the cover (4)) is set such that no reflected radio wave, which is transmitted by the radio wave sensor (2A) and reflected by the cover (4), by the receiving surface (210) and again by the cover (4) and has a signal intensity higher than a reception sensitivity of the radio wave sensor (2A), is incident on the receiving surface (210) of the antenna (21).

Regarding a luminaire (1A) of a sixth aspect, in any one of the first to the fifth aspects, the cover (4) is made of glass.

Regarding a luminaire (1A) of a seventh aspect, in any one of the first to the fifth aspects, the cover (4) is made of resin.

Regarding a luminaire (1A) of an eighth aspect, in the seventh aspect, the cover (4) is made of the resin that has a dielectric constant less than a dielectric constant of glass.

Regarding a luminaire (1A) of a ninth aspect, in any one of the first to the eighth aspects, the cover (4) has a flat plane shape.

The luminaire (1A) can reduce occurrence of erroneous detection due to reflection waves reflected by the cover (4).

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A luminaire, comprising:
a radio wave sensor configured to detect, by using radio waves, movement of an object within a detection area by a Doppler Effect due to the movement of the object;
a luminaire body holding the radio wave sensor; and
a cover attached to the luminaire body and covering the radio wave sensor, the cover allowing the radio waves to pass through,
the radio wave sensor including an antenna for transmitting/receiving the radio waves, and
a receiving surface of the antenna for receiving the radio waves being inclined relative to the cover.

2. The luminaire according to claim 1, wherein:
the antenna is disposed at a position where a shortest distance between the receiving surface and the cover is equal to or more than a wavelength of the radio waves to be transmitted by the radio wave sensor.

3. The luminaire according to claim 2, wherein:
the antenna is disposed at a position where the shortest distance between the receiving surface and the cover is equal to or more than twice as long as the wavelength of the radio waves to be transmitted by the radio wave sensor.

4. The luminaire according to claim 1, wherein:
the receiving surface of the antenna is provided so as to be inclined relative to the cover by an angle at which a specific radio wave reflected by the cover, of radio waves transmitted by the radio wave sensor, is not incident on the receiving surface, the specific radio wave having a signal intensity higher than a reception sensitivity of the radio wave sensor.

5. The luminaire according to claim 1, wherein:
the receiving surface of the antenna is provided so as to be inclined relative to the cover by an angle at which a specific radio wave reflected by the cover and the receiving surface in this order and then again reflected by the cover, of radio waves transmitted by the radio wave sensor, is not incident on the receiving surface, the specific radio wave having a signal intensity higher than a reception sensitivity of the radio wave sensor.

6. The luminaire according to claim 1, wherein the cover is made of glass.

7. The luminaire according to claim 1, wherein the cover is made of resin.

8. The luminaire according to claim 7, wherein the cover is made of the resin that has a dielectric constant less than a dielectric constant of glass.

9. The luminaire according to claim 1, wherein the cover has a flat plane shape.
